(19) United States
(12) Patent Application Publication
(10) Pub. No.: US 2017/0241794 A1
(43) Pub. Date: Aug. 24, 2017

(54) METHOD AND APPARATUS FOR PREDICTING VEHICLE ROUTE

(71) Applicant: ELECTRONICS AND TELECOMMUNICATIONS RESEARCH INSTITUTE, Daejeon (KR)

(72) Inventors: Yong Bon KOO, Daejeon (KR); Woo Yong HAN, Daejeon (KR)

(21) Appl. No.: 15/403,637

(22) Filed: Jan. 11, 2017

(30) Foreign Application Priority Data
Feb. 18, 2016 (KR) 10-2016-0019216

(51) Int. Cl. G01C 21/36; G08G 1/0962; G06K 9/00; G08G 1/16

(52) U.S. Cl. CPC G01C 21/3617; G08G 1/167; G08G 1/09623; G06K 9/00818

(57) ABSTRACT

The vehicle route prediction apparatus includes a lane recognition unit configured to recognize a type of each of a left lane and a right lane with respect to a driving vehicle, a position recognition unit configured to obtain latitude and longitude coordinates of the driving vehicle, a storage unit configured to store map data, including road information, and a route prediction model, and an arithmetic operation unit configured to check an identifier of an intersection which the driving vehicle intends to enter, based on a position of the driving vehicle and the map data stored in the storage unit, check a position of a lane, based on the type of each of the left lane and the right lane recognized by the lane recognition unit, predict a route of the driving vehicle by using the route prediction model corresponding to an ID of the intersection.

### CROSS-REFERENCE TO RELATED APPLICATIONS

This application claims priority under 35 U.S.C. §119 to Korean Patent Application No. 10-2016-0019216, filed on Feb. 18, 2016, the disclosure of which is incorporated herein by reference in its entirety.

### BACKGROUND OF THE INVENTION

1. Field of the Invention

The present invention relates to a method and apparatus for predicting a vehicle driving route, and more particularly, to a method and apparatus for predicting an estimated driving route of a vehicle which has entered an intersection.

2. Description of Related Art

Driving route guide apparatuses such as navigations or various guide systems for intelligent vehicles which are being released at present are configured to previously notify information such as speed cameras, speed bumps, children protection zones, and/or the like.

However, such guide has a problem where pieces of information within a certain radius are provided based on position information about a vehicle irrespective of a driving route of the vehicle to rather cause a confusion of a driver.

In the related art, Korean Patent Publication No. 10-2013-0007754 discloses a method and an apparatus for controlling vehicles on an autonomous driving intersection, which calculate an entry estimation time of each of vehicles which enter an intersection, determine a collision risk, and issue a warning to vehicles intending to enter the intersection, or directly control the vehicles.

However, in the related art, information about an intersection should be obtained through a vehicle monitoring apparatus installed on the intersection of a road. For this reason, the related art cannot be used for the existing road, and since only a crossing time of a vehicle which has entered the intersection can be determined, it is unable to predict a driving route of the vehicle.

### SUMMARY

Accordingly, the present invention provides a method and apparatus for predicting drivability of a vehicle on each road, based on a past driving history of the vehicle which has entered an intersection.

The object of the present invention is not limited to the aforesaid, but other objects not described herein will be clearly understood by those skilled in the art from descriptions below.

In one general aspect, a vehicle route prediction apparatus includes: a lane recognition unit configured to recognize a type of each of a left lane and a right lane with respect to a driving vehicle by using a camera, a Lidar sensor, or a radar sensor; a position recognition unit configured to obtain latitude and longitude coordinates of the driving vehicle; a storage unit configured to store map data, including road information, and a route prediction model storing an exit road-based driving history and an entry lane-based driving history of vehicles passing through an intersection included in the map data; and an arithmetic operation unit configured to check an identifier (ID) of an intersection which the driving vehicle intends to enter, based on a position of the driving vehicle checked by the position recognition unit and the map data stored in the storage unit, check a position of a lane on which the driving vehicle is currently driving, based on the type of each of the left lane and the right lane recognized by the lane recognition unit, predict a route of the driving vehicle by using the route prediction model corresponding to an ID of the intersection, and store the lane, on which the driving vehicle is driving, in the route prediction model.

In another general aspect, a vehicle route prediction method includes: determining a position of a vehicle; determining whether the vehicle enters an intersection, based on the determined position and pre-stored map data; determining whether there is a route prediction model corresponding to the intersection, and when there is no route prediction model as a result of the determination, generating and storing a route prediction model; when there is the route prediction model, recognizing a type of each of a left lane and a right lane with respect to the vehicle to determine a lane on which the vehicle is driving, based on the recognized type; predicting a route of the vehicle by using the determined driving lane of the vehicle and the stored route prediction model corresponding to the intersection; and storing the driving lane of the vehicle and an exit road of the intersection in the route prediction model.

Other features and aspects will be apparent from the following detailed description, the drawings, and the claims.

### BRIEF DESCRIPTION OF THE DRAWINGS

FIG. 1 is a diagram illustrating a structure of an intersection to which an embodiment of the present invention is applied.

FIG. 2 is a block diagram illustrating a structure of a vehicle route prediction apparatus according to an embodiment of the present invention.

FIG. 3 is a flowchart illustrating a vehicle route prediction method according to another embodiment of the present invention.

FIG. 4 is a block diagram showing a computer system according to another embodiment of the present invention.

### DETAILED DESCRIPTION OF EMBODIMENTS

The advantages, features and aspects of the present invention will become apparent from the following description of the embodiments with reference to the accompanying drawings, which is set forth hereinafter. The present invention may, however, be embodied in different forms and should not be construed as limited to the embodiments set forth herein. Rather, these embodiments are provided so that this disclosure will be thorough and complete, and will fully convey the scope of the present invention to those skilled in the art. The terms used herein are for the purpose of describing particular embodiments only and are not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Hereinafter, embodiments of the present invention will be described in detail with reference to the accompanying drawings.

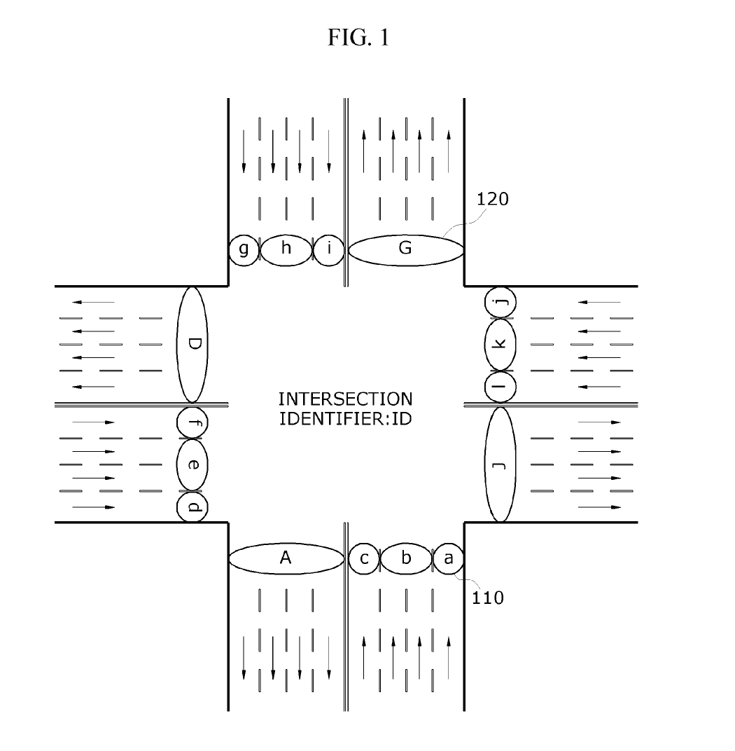

FIG. 1 is a diagram illustrating a structure of an intersection where route prediction according to an embodiment of the present invention is performed.

FIG. 1 illustrates an intersection where four roads meet at one point. In FIG. 1, a Y-shaped intersection may include three roads as elements, and a star(*)-shaped intersection may include five roads.

A lane may represent the number of one-way roads of each road, and as in FIG. 1, when a road includes four one-way roads, the road may include four lanes. Therefore, a six-lane road includes three one-way lanes, and a two-lane road includes one one-way lane.

An embodiment of the present invention will be described with respect to an environment where vehicles drive on the right of a road, but by using the left-right symmetrical characteristic of each road, an embodiment of the present invention may be easily applied to an environment where vehicles drive on the left of a road.

A route prediction model according to an embodiment of the present invention may be generated for each intersection, and thus, the intersection of FIG. 1 may have an intersection identifier (ID) and may correspond to an intersection of map data in a relationship of 1:1.

Each road may be divided into an entry lane which enters an intersection and an exit lane which exits from the intersection. In FIG. 1, each of entry lanes may be marked by a small-letter identification sign 110 like a, b, c, . . . j, k, and l, and each of exit lanes may be marked by a capital-letter identification sign 120 like A, D, G, and J.

The exit lane may be marked by one identification sign 120 irrespective of the number of lanes, and the number of identification signs 110 which respectively mark the entry lanes may vary based on the number of lanes. When the number of lanes is three or more, the number of identification signs may be three, and when the number of lanes is two or one, the number of identification signs may be two or one. That is, when the number of lanes is three or more, lanes other than two outermost lanes may have the same identification sign 110.

The route prediction model may include Table 1 storing an entry lane-based driving history and Table 2 storing a driving history corresponding to an exit lane. Also, the route prediction model may include Table 3 which stores a driving history obtained by combining the entry lane and the exit lane.

TABLE 1

| Entry Lane | |
|---|---|
| Identification | Driving |
| Sign | History |
| a | nₐ |
| b | n_{b} |
| c | n_{c} |
| d | n_{d} |
| e | nₑ |
| f | n_{f} |
| g | n_{g} |
| h | nₕ |
| i | nᵢ |
| j | nⱼ |
| k | nₖ |
| l | nₗ |

TABLE 2

| Exit Lane | |
|---|---|
| Identification | Driving |
| Sign | History |
| A | n_{A} |
| D | n_{D} |
| G | n_{G} |
| J | n_{J} |

TABLE 3

| | U | | Go Straight | Right Turn |
|---|---|---|---|---|
| | Turn (A) | Left Turn (D) | (G) | (J) |
| Rightmost | B_{aA} | B_{aD} | B_{aG} | B_{aJ} |
| Lane (a) | | | | |
| Central Lane | B_{bA} | B_{bD} | B_{bG} | B_{bJ} |
| (b) | | | | |
| Leftmost Lane | B_{cA} | B_{cD} | B_{cG} | B_{cJ} |
| (c) | | | | |

For example, when a vehicle enters a lane marked as an identification sign “b” of FIG. 1 and exits through a lane marked as an identification sign “D”, n_{b} which is a driving history of a lane “b” may increase by one in Table 1 which is an entry lane table, and n_{D} which is a driving history of a lane “D” may increase by one in Table 2 which is an exit lane table. Also, B_{bD} which is a combination when a vehicle turns to the left from a central lane “b” to the lane “D” may increase by one in Table 3 which is a combination table of the entry lane and the exit lane, thereby updating a model.

A route of the vehicle may be predicted based on the updated model. If the number of times the vehicle enters the lane “b” and travels to an exit lane “G” is large, a value of B_{bG} may have a largest value in Table 3. Therefore, if the vehicle is traveling to the lane “b”, a vehicle guide system may previously provide information associated with a G road, thereby preventing confusion of a driver.

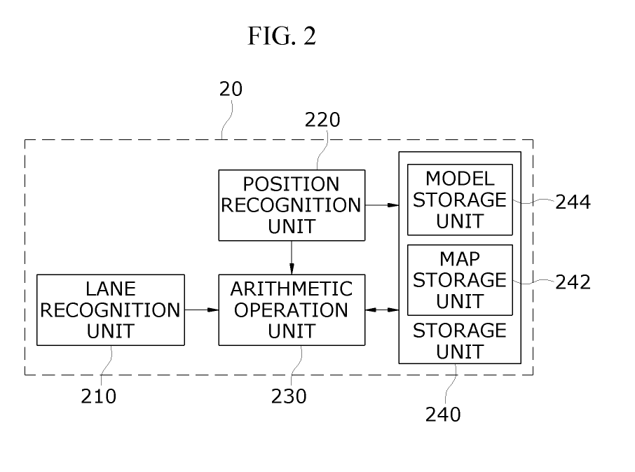

FIG. 2 is a block diagram illustrating a structure of a vehicle route prediction apparatus 20 according to an embodiment of the present invention.

The vehicle route prediction apparatus 20 may include a lane recognition unit 210, a position recognition unit 220, an arithmetic operation unit 230, and a storage unit 240. The storage unit 240 may include a model storage unit 242 and a map storage unit 244.

The lane recognition unit 210 may recognize whether the type of each of a left lane and a right lane with respect to a driving vehicle is a dotted line or a solid line, by using a sensor such as a camera, a Lidar device, or radar device and may supply a result of the recognition to the arithmetic operation unit 230.

The position recognition unit 220 may obtain latitude and longitude coordinates of a current position of the driving vehicle by using a sensor such as a global positioning system (GPS) or the like and may supply the latitude and longitude coordinates to the arithmetic operation unit 230. The position recognition unit 220 may use all sensors which have an error rate within 10 m which is a maximum error.

Alternatively, the position recognition unit 220 may take a picture of a road sign of a road, on which the vehicle is driving, by using a camera and may determine a position of the vehicle, based on latitude and longitude information on a map. To this end, information about road signs and information about positions of the road signs may be previously added into map data stored in the map storage unit 242.

The arithmetic operation unit 230 may check an ID of an intersection which the vehicle intends to enter, based on a result of the recognition by the position recognition unit 220 and a map stored in the map storage unit 244 and may manage tables corresponding to IDs of intersections stored in the model storage unit 242.

Moreover, a route of the vehicle may be predicted by using the lane recognition unit 210, the position recognition unit 220, and information stored in the model storage unit 242, and the route prediction model may be updated by using a driving result of the vehicle.

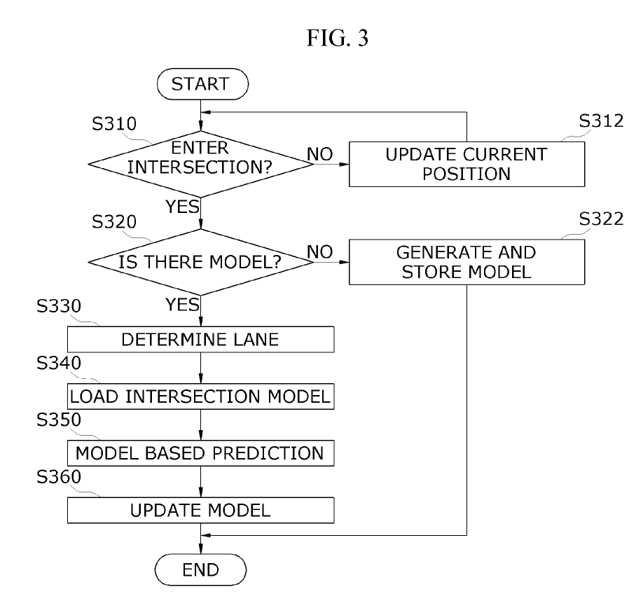

FIG. 3 is a flowchart illustrating a vehicle route prediction method according to another embodiment of the present invention.

In step S310, the vehicle route prediction apparatus may check a current position of a vehicle by using the position recognition unit 220 such as the GPS and may determine whether the vehicle enters an intersection.

When it is determined that the vehicle does not enter the intersection, the vehicle route prediction apparatus may update the current position in step S312 and may repeat an operation (S310) of determining whether the vehicle enters the intersection. In this case, the current position may be continuously updated in the map storage unit 244.

When it is determined that the vehicle enters the intersection, the vehicle route prediction apparatus may search the model storage unit 242 to determine whether the route prediction model is stored in the model storage unit 242, based on position information and ID information about intersections stored in the map storage unit 244 in step S320.

When it is determined that the route prediction model is not stored in the model storage unit 242, the vehicle route prediction apparatus may newly generate an intersection route prediction model in the above-described manner, based on intersection information such as intersection IDs, the number of roads, and the number of lanes extracted from the map storage unit 244 and may store the newly generated intersection route prediction model in the model storage unit 242 in step S322.

When the route prediction model is stored in the model storage unit 242 as a result of the search, the vehicle route prediction apparatus may determine an entry lane of the vehicle, based on lane information of FIG. 1 and lane information recognized by the lane recognition unit 210 in step S330.

The following Table 4 shows a lane weight model for determining a driving lane based on recognition of a left lane and a right lane.

TABLE 4

| Left lane recognition | Right lane recognition | Lane weight value |
|---|---|---|
| Solid line | Solid line | a 0.5, c 0.5 |
| Solid line | Dotted line | c 1 |
| Dotted line | Solid line | a 1 |
| Dotted line | Dotted line | b 1 |
| Unrecognizable | Solid line | a 1 |
| Unrecognizable | Dotted line | b 0.5, c 0.5 |
| Solid line | Unrecognizable | c 1 |
| Dotted line | Unrecognizable | a 0.5, b 0.5 |
| Unrecognizable | Unrecognizable | a 0.3, b 0.3, c 0.3 |

A result of recognition by the lane recognition unit 210 may show three types such as a solid line, a dotted line, and unrecognizable. The lane weight value shown in Table 4 may be determined based on a result of the left lane recognition and a result of the right lane recognition, and an entry lane may be determined based on the lane weight value.

As seen in “a, b, and c” lanes of FIG. 1, “a” may represent a rightmost lane, “b” may represent a central lane, and “c” may represent a leftmost lane.

When a weight value is determined based on lane recognition, the vehicle route prediction apparatus may load an intersection model in step S340, calculate a prediction value according to the route prediction model in step S350, and update the intersection model with the calculated prediction value in step S360.

The route prediction model may store a row of numbers which is four times larger than the number of roads configuring each of intersections. In this case, each of the roads may have identification signs “a to l” corresponding to three entry lanes and identification signs “A, D, G and J” corresponding to one entry lane.

When a vehicle is driving in a direction toward an entry lane having identification signs “a, b and c”, the vehicle route prediction apparatus may determine lane-based weight values “kₐ, k_{b} and k_{c}”, based on results of the left and right lane recognitions by the lane recognition unit 210.

When the vehicle is driving on one of lanes “a, b and c”, an exit lane “A” may be an exit lane corresponding to U turn, an exit lane “D” may be an exit lane corresponding to left turn, an exit lane “G” may be an exit lane corresponding to go straight, and an exit lane “J” may be an exit lane corresponding to right turn. In this case, since there is a difference in facilitation of exit to exit lanes “A, D, G and J” depending on a position of an entry lane of the vehicle, in order to reflect the difference, a correction value may be determined and may be stored in the route prediction model in the types of Tables 1, 2, and 3.

When the vehicle enters the lane “A”, the prediction value “P_{A}” may be determined as expressed in the following Equation (1), and when the vehicle enters the lane “D, G or J”, the prediction value “P_{A}” may be easily calculated by modifying the following Equation (1):

$${P}_{A} = {\sum }_{i ∈ \{ a , b , c \}} {k}_{i} ( \frac{{n}_{A} + {B}_{iA}}{{\sum }_{j ∈ \{ A , D , G , J \}} {n}_{j} + {B}_{ij}} ) \qquad ( 1 )$$

Values necessary for Equation (1) may be stored in the model storage unit 242 in a table type in Tables 1, 2 and 3.

An entry road of a vehicle may be predicted by the route prediction method, and an apparatus such as a vehicle guide system or a navigation device may provide a driver with only information associated with a predicted exit road, thereby preventing confusion of the driver and more effectively transferring information.

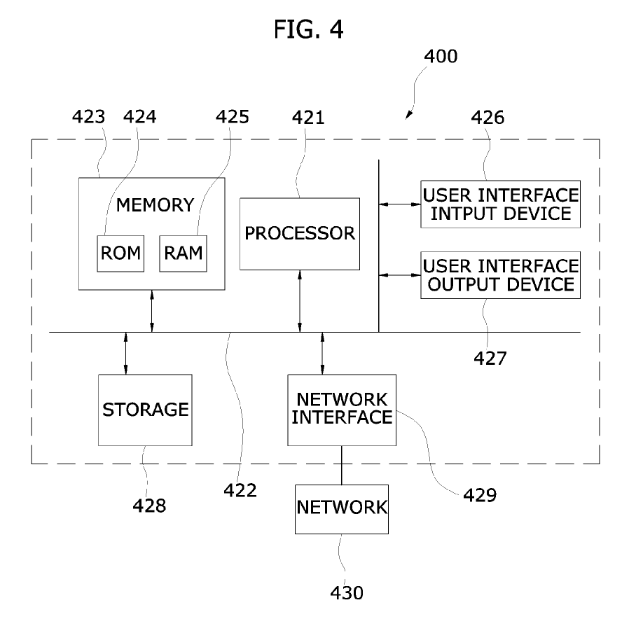

The vehicle route prediction method according to an embodiment of the present invention may be implemented in a computer system or recorded in a recording medium. As shown in FIG. 4, a computer system may include at least one processor 421, a memory 423, a user input device 426, a data communication bus 422, a user output device 427, and a storage 428. The above-described elements perform data communication through the data communication bus 422.

The computer system may further include a network interface 429 that is coupled to a network. The processor 421 may be a central processing unit (CPU), or a semiconductor device that processes instructions stored in the memory 423 and/or the storage 428.

The memory 423 and the storage 428 may include various forms of volatile or non-volatile storage media. For example, the memory 423 may include a read only memory (ROM) 424 and a random access memory (RAM) 425.

Accordingly, the vehicle route prediction method according to an embodiment of the present invention may be implemented in a method that is executable in a computer. When the vehicle route prediction method according to an embodiment of the present invention is performed in a computer device, computer-readable instructions may perform the recognition method according to an embodiment of the present invention.

The vehicle route prediction method according to an embodiment of the present invention can also be implemented as computer-readable codes in a computer-readable recording medium. The computer-readable recording medium includes any type of recording device for storing data which may be read by the computer device. Examples of the computer readable recording medium may include a ROM, a RAM, a magnetic disk, a flash memory, optical data storage device, etc. The computer readable recording medium can also be distributed over computer systems connected through a computer communication network so that the computer readable code is stored and executed in a distributed fashion.

According to the embodiments of the present invention, since a driving route on an intersection is predicted based on a driving history of a vehicle, thereby enhancing an accuracy of information supplied from a navigation device or a vehicle guide system.

Moreover, the vehicle route prediction method and apparatus according to the embodiments of the present invention may be applied to the autonomous driving technology and may be used to predict a destination of a vehicle, a driving route of another vehicle, etc., and moreover, may be used to set a route of an autonomous driving vehicle in addition to a driver assistance system.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A vehicle route prediction apparatus comprising:
a lane recognition unit configured to recognize a type of each of a left lane and a right lane with respect to a driving vehicle by using a camera, a Lidar sensor, or a radar sensor;
a position recognition unit configured to obtain latitude and longitude coordinates of the driving vehicle;
a storage unit configured to store map data, including road information, and a route prediction model storing an exit road-based driving history and an entry lane-based driving history of vehicles passing through an intersection included in the map data; and
an arithmetic operation unit configured to check an identifier (ID) of an intersection which the driving vehicle intends to enter, based on a position of the driving vehicle checked by the position recognition unit and the map data stored in the storage unit, check a position of a lane on which the driving vehicle is currently driving, based on the type of each of the left lane and the right lane recognized by the lane recognition unit, predict a route of the driving vehicle by using the route prediction model corresponding to an ID of the intersection, and store the lane, on which the driving vehicle is driving, in the route prediction model.

2. The vehicle route prediction apparatus of claim 1, wherein the position recognition unit obtains the latitude and longitude coordinates of the driving vehicle by using a global positioning system (GPS).

3. The vehicle route prediction apparatus of claim 1, wherein the position recognition unit recognizes a road sign by using the camera and compares the recognized road sign with a road sign included in the map data stored in the storage unit to obtain the latitude and longitude coordinates of the driving vehicle.

4. The vehicle route prediction apparatus of claim 1, wherein when the type of each of the left lane and the right lane recognized by the lane recognition unit is a solid line, a dotted line, or unrecognizable, the arithmetic operation unit determines a position of a driving lane on which the driving vehicle is driving, based on a lane weight value of Table 5,
TABLE 5

| Left lane recognition | Right lane recognition | Lane weight value |
|---|---|---|
| Solid line | Solid line | a 0.5, c 0.5 |
| Solid line | Dotted line | c 1 |
| Dotted line | Solid line | a 1 |
| Dotted line | Dotted line | b 1 |
| Unrecognizable | Solid line | a 1 |
| Unrecognizable | Dotted line | b 0.5, c 0.5 |
| Solid line | Unrecognizable | c 1 |
| Dotted line | Unrecognizable | a 0.5, b 0.5 |
| Unrecognizable | Unrecognizable | a 0.3, b 0.3, c 0.3 |

where “a” represents a rightmost lane, “c” represents a leftmost lane, and “b” represents a central lane.

5. The vehicle route prediction apparatus of claim 4, wherein the arithmetic operation unit predicts an exit road of the driving vehicle, based on Equation:
$${P}_{A} = {\sum }_{i ∈ \{ a , b , c \}} {k}_{i} ( \frac{{n}_{A} + {B}_{iA}}{{\sum }_{j ∈ \{ A , D , G , J \}} {n}_{j} + {B}_{ij}} )$$
where P_{X} denotes a probability of entry to an X road, the X road denotes all roads (X=A or D or G or J) capable of exiting in the intersection, kᵢ denotes a weight value of the i lane, n_{X} denotes number of times the vehicle enters the X road, and B_{iX} denotes number of times the vehicle enters the i lane and exist through the X road.

6. A vehicle route prediction method comprising:
determining a position of a vehicle;
determining whether the vehicle enters an intersection, based on the determined position and pre-stored map data;
determining whether there is a route prediction model corresponding to the intersection, and when there is no route prediction model as a result of the determination, generating and storing a route prediction model;
when there is the route prediction model, recognizing a type of each of a left lane and a right lane with respect to the vehicle to determine a lane on which the vehicle is driving, based on the recognized type,
predicting a route of the vehicle by using the determined driving lane of the vehicle and the stored route prediction model corresponding to the intersection; and
storing the driving lane of the vehicle and an exit road of the intersection in the route prediction model.

7. The vehicle route prediction method of claim 6, wherein the determining of the position comprises obtaining latitude and longitude coordinates of the vehicle by using a global positioning system (GPS) to determine the position of the vehicle.

8. The vehicle route prediction method of claim 6, wherein the determining of the position comprises recognizing a road sign with a camera and comparing the recognized road sign with a road sign included in the pre-stored map data to obtain latitude and longitude coordinates of the vehicle, thereby determining the position of the vehicle.

9. The vehicle route prediction method of claim 6, wherein the recognizing of the type comprises recognizing the type of each of the left lane and the right lane with respect to the vehicle by using a camera, a Lidar sensor, or a radar sensor.

10. The vehicle route prediction method of claim 6, wherein the determining of the lane comprises, when the recognized type of each of the left lane and the right lane is a solid line, a dotted line, or unrecognizable, determining a position of a driving lane on which the vehicle is driving, based on a lane weight value of Table 5,
TABLE 5

| Left lane recognition | Right lane recognition | Lane weight value |
|---|---|---|
| Solid line | Solid line | a 0.5, c 0.5 |
| Solid line | Dotted line | c 1 |
| Dotted line | Solid line | a 1 |
| Dotted line | Dotted line | b 1 |
| Unrecognizable | Solid line | a 1 |
| Unrecognizable | Dotted line | b 0.5, c 0.5 |
| Solid line | Unrecognizable | c 1 |
| Dotted line | Unrecognizable | a 0.5, b 0.5 |
| Unrecognizable | Unrecognizable | a 0.3, b 0.3, c 0.3 |

where a represents a rightmost lane, c represents a leftmost lane, and b represents acentral lane.

11. The vehicle route prediction method of claim 10, wherein the predicting of the route comprises predicting an exit road of the vehicle, based on Equation:
$${P}_{A} = {\sum }_{i ∈ \{ a , b , c \}} {k}_{i} ( \frac{{n}_{A} + {B}_{iA}}{{\sum }_{j ∈ \{ A , D , G , J \}} {n}_{j} + {B}_{ij}} )$$
where P_{X} denotes a probability of entry to an X road, the X road denotes all roads (X=A or D or G or J) capable of exiting in the intersection, kᵢ denotes a weight value of the i lane, n_{X} denotes number of times the vehicle enters the X road, and B_{iX} denotes number of times the vehicle enters the i lane and exist through the X road.
